(19) United States
(12) Patent Application Publication
(10) Pub. No.: US 2023/0076701 A1
(43) Pub. Date: Mar. 9, 2023

(54) WORKING VEHICLE ATTACHMENT TOWER, WORKING VEHICLE ATTACHMENT DEVICE, SET OF A PLURALITY OF WORKING VEHICLE ATTACHMENT TOWERS AND METHOD FOR MANUFACTURING A WORKING VEHICLE ATTACHMENT TOWER

(71) Applicant: Wilhelm Stoll Maschinenfabrik GmbH, Lengede/Broistedt (DE)

(72) Inventor: Jens Körner, Magdeburg (DE)

(21) Appl. No.: 17/903,570

(22) Filed: Sep. 6, 2022

(30) Foreign Application Priority Data
Sep. 7, 2021 (DE) 20 2021 104 817.4

(51) Int. Cl. A01B 59/048; E02F 3/627

(52) U.S. Cl. CPC A01B 59/048; E02F 3/627

(57) ABSTRACT

The present invention relates to a working vehicle attachment tower which comprises a front loader mounting body and a supporting body. The front loader mounting body and the supporting body are manufactured as separate parts and welded to each other by at least one weld seam. The supporting body is manufactured by use of a massive forming process. Furthermore, the invention relates to a set of a plurality of working vehicle attachment towers and a method for manufacturing a working vehicle attachment tower.

### CROSS REFERENCE TO RELATED APPLICATIONS

This application claims priority to co-pending German Utility Model Application No. DE 20 2021 104 817.4 filed Sep. 7, 2021.

### FIELD OF THE INVENTION

The present invention relates to a working vehicle attachment device and components thereof. A working vehicle attachment device serves for mounting a front loader to a working vehicle (in particular (agricultural) tractor). Furthermore, the invention relates to a set of working vehicle attachment towers and a method for manufacturing a working vehicle attachment tower.

### BACKGROUND OF THE INVENTION

On the website
https://stoll-germany.com/de/frontlader/stoll-profiline
(Date of inspection: Application date of the priority application)

a working vehicle attachment device is shown. The components of the working vehicle attachment device are being named attachment parts. Here, one attachment part is a frame element which in a state assembled to the working vehicle extends approximately horizontally and which can be attached in a front attachment portion and a rear attachment portion to the working vehicle, in particular to a chassis, a longitudinal carrier or a drive train. A tower is assembled centrically with the frame element. In the assembled state the tower extends approximately in vertical direction. In the upper end region the tower comprises a front loader attachment body which is here shown in an embodiment which is also denoted as “bone”. In the region of the bone the front loader is assembled and fixed to the tower. The frame element is embodied as a deformed metal sheet part whereas the tower is a welded assembly group.

The publication EP 3 158 842 B1 discloses a working vehicle attachment device wherein the frame element is attached on the drive train of the working vehicle. The front attachment portion of the frame element is here attached to the front carriage frame whereas a rear attachment portion of the frame element is attached to the flywheel housing. Also here the working vehicle attachment tower is screwed to the frame element at a location between the front attachment portion and the rear attachment portion. It is possible that the frame element comprises a structured surface and is embodied as a cast component.

### SUMMARY OF THE INVENTION

The present invention proposes a working vehicle attachment tower. A working vehicle attachment tower of this type is in the English-speaking area also denoted as “tower” and in the state assembled to the working vehicle extends approximately in vertical direction. The working vehicle attachment tower comprises a front loader attachment body which also covers a front loader attachment body which is colloquially named as “bone”. The front loader attachment body comprises an accommodation for a front loader and serves for holding the front loader at the working vehicle attachment tower and so at the working vehicle. Furthermore, the working vehicle attachment tower comprises a supporting body which carries the front loader attachment body in the end region arranged on top in the assembled state and which extends in vertical direction. By means of the supporting body the accommodation for the front loader provided by the front loader attachment body is displaced vertically in upper direction, e.g. from a chassis or frame towards a height of the upper end region or above an engine hood of the working vehicle. Here, the supporting body in particular
has a massive design,
is a solid body without hollow or open inner chambers and
is not manufactured from one metal sheet or a plurality of metal sheets of a welded assembly group and
is no embodied as a cast component.

The front loader attachment body on the one hand and the supporting body on the other hand are manufactured separately from each other. The separate manufacturing allows that in some cases different processes can be used for the manufacturing and/or (even when using the same manufacturing processes) to use different process parameters for the manufacturing process. Furthermore, the separate manufacturing allows that for the front loader attachment body on the one hand and the supporting body on the other hand different materials can be used. After the separate manufacturing the front loader attachment body and the supporting body are welded to each other.

The supporting body is manufactured by use of a massive forming process.

Within the frame of the invention a massive forming process is understood to be a process wherein a three-dimensional blank is deformed three-dimensionally wherein in the massive forming process the blank preferably undergoes plastic deformations in three dimensional directions. It is e.g. possible that in the massive forming process two die parts or an anvil and a punch are moved in a first direction towards each other which leads to a compressing plastic deformation of the blank in this first direction and at the same time to a floating of material of the blank into a second and/or third direction being in particular orthogonal to each other and to the first direction. The massive forming here covers e.g. a drop forging or die forging or an extrusion or impact extrusion or an open die forging, hammer forging or hand forging. The massive forming process is delimited from or does not cover a metal sheet deformation wherein approximately two-dimensional workpieces (namely metal sheets) are deformed without significant changes of the thickness of the metal sheet. Further information for the massive forming process can e.g. be taken from
the technical literature “Industrieverband Massivumformung: Fachbuch Massivumformung kurz and bündig, April 2013, ISBN 978-3-928726-32-0” and
the handbook “Eckhart Doege, Bernd-Arno Behrens: Handbuch Umformtechnik: Grundlagen, Technologien, Maschinen, Springer-Verlag (Berlin/Heidelberg), 2010, ISBN 978-3-642-04248-5”.

The massive forming process might also be a cold massive forming process performed at room ambient temperature up to a maximum of 500° C., a medium temperature massive forming process performed at temperatures from 500° C. to approximately 800° C. or a hot massive forming process performed between 1,000° C. and a maximum of 1,300° C. The blank might e.g. a rolled steel rod (e.g. comprising a round or rectangular cross section), an extruded profile or a cast blank. In an open die forging, hammer forging or hand forging a cast block of any geometry can be deformed. In a massive forming the blank is deformed plastically in a non-cutting or non-machining way by means of tools under high forces. By a massive forming process any present pores can be closed and inclusions (together with the microstructure) can be stretched in floating direction of the material. By means of massive formed components it is possible produce typical stretched microstructures or fiber structures comprising an increased resilience in particular in the direction of the stretching or of the fiber orientation. By a suitable choice of the forming direction it is possible to achieve a specific adaption of the main stress orientations. Depended on the forming temperature a microstructure might be strain-hardened or cold worked hardened or re-crystallized with a fine granulation. Depended on the combination of the alloy or composition and the process control the hot forming process might already provide a thermo-mechanical treatment with positive effects on the microstructure and the mechanical properties related therewith. As tools for the massive forming process any metals or metal alloys can be used (e.g. construction steel or structural steel, carbons steel, heat-treated steel, high-alloy steel). Preferably, for the cold forming process only steel types are used having a carbon content of approximately 0.5% and/or the sum of the alloy components being limited to approximately 5%. According to DIN 8582 common manufacturing processes used for the massive forming processes are associated to the group of “pressure forming” which is subdivided into rolling or milling, free forming, die forming, impressing or spiring and pushing through or extrusion. Preferably, a drop forging is used wherein the forging temperature is e.g. in the region of 1,150° C. to 1,250° C. It is also possible that the supporting body is manufactured by use of an open-die forging, hammer forging or flat die forging wherein an incremental deformation is induced and wherein with a plurality of pressing strokes the desired geometry is achieved.

To date the prior art only teaches to manufacture the working vehicle attachment tower as a welded assembly group wherein the supporting body consists of a plurality of metal sheets which have been deformed to a complex shaped, put together and welded to each other or to manufacture the working vehicle attachment tower as a cast component. The proposed manufacturing of the supporting body by a massive forming process is advantageous because when using a massive forming process higher strengths than the strengths according to the prior art can be achieved and also limitations with respect to the geometry of the supporting body as being present for the design as a welded assembly group or cast component to not exist or are reduced. When using a massive forming process also designs of the geometry of the supporting body differing from the geometry known from the prior art are possible which might be advantageous for the optical appearance of the working vehicle attachment tower but also for the constructional space conditions. The provision of a higher strengths of the supporting body by means of the massive forming process might also lead to the result that the supporting body might have a smaller cross section which reduces the line-of-sight obstruction by the supporting body and/or extends the available constructional space next to the supporting body. Finally, the supporting body manufactured by means of the massive forming process can also be used for supporting higher loads applied by the front loader, by the implement attached to the front loader and by the forces biasing the implement and for transferring the same.

A working vehicle attachment tower of this type is in particular improved with respect to
the options for the manufacturing and/or
the manufacturing effort and/or
the options for the choice of the material and/or
the mechanical properties, in particular the strength and/or hardness, and/or
the shaping and/or
the constructional space properties.

It is possible that the lower front face of the front loader attachment body contacts an upper front face of the supporting body and that the weld seams for connecting the front loader attachment body and the supporting body are arranged laterally from the contact surface. In the case that the front loader attachment body comprises a larger lateral extension than the supporting body there is a step laterally from the contact surface at the transition from the supporting body to the front loader attachment body. In this case the weld seam located at the step might be embodied as a fillet weld or hollow weld. Instead, if the lateral extension of the front loader attachment body is not larger than the lateral extension of the supporting body or in the case that the space available for the fillet weld or hollow weld should be increased it is also possible that the supporting body comprises a chamfered edge or a portion of reduced thickness in the region of the weld seam by which the front loader attachment body is welded to the supporting body. The chamfered edge or portion can then be filled with the weld seam so that it is possible that the weld seam is flush with the outer surface of the supporting body or even protrudes from the same in lateral direction. Accordingly, in this way it is on the one hand possible to change the geometry of the weld seam and on the other hand to increase the space available for the weld seam so that it is also possible to use a thicker weld seam for improving the connection and increasing the strength. Here, the chamfered edge or the portion having a reduced thickness is in particular manufactured already during the massive forming process.

For the way of manufacturing the front loader attachment body there are a lot of options. Preferably the front loader attachment body is manufactured by means of a massive forming process or a forging process (being a special type of the massive forming process).

It is possible that there is a post-processing or finishing or further treatment of the front loader attachment body and the supporting body (e.g. by metal-cutting or machining or a grinding process) in order to provide a full surface contact in the region of the contact surface and/or to provide an optimal preparation of the weld seam without troublesome or over-dimensioned gaps or joints between the supporting body and the front loader attachment body. However, for one proposal the supporting body is manufactured in the massive forming process with a front face contacted by the front loader attachment body having a tolerance which is ±1 mm in vertical direction of the front face. The corresponding might apply for the front loader attachment body. This embodiment bases on the finding that it might be advantageous if there is no additional processing of the front face as explained above because in some cases this additional manufacturing process drastically increases the manufacturing effort and the cost. If on the other hand for the massive forming process the design of the tools and the choice of the process parameters are chosen in a way such that the tolerance is in the region of ±1 mm, nevertheless the contact can be provided in the region of the front faces. It has been noted that any local interspaces, joints or gaps have no negative effect on the force transmission between the front loader attachment body and the supporting body when the aforementioned tolerances apply. Furthermore, it has been noted that interspaces, joints or gaps of this type can be filled in a simple way by the weld seam and/or bridged by the same without the consequence of significant reductions of the strength.

It is possible that the supporting body is a leg or extrusion having a cross sectional area only slightly varying along its longitudinal extension (so in the heights direction in the assembled state) or even not significantly varying cross sectional geometry wherein then the front loader attachment body can be arranged in the upper end region whereas an attachment to a frame element (which can again be attached to the vehicle frame, the chassis, a longitudinal carrier or the drive train of the working vehicle) can be provided in the lower end region. For one proposal the supporting body comprises a frame element attachment portion in the end region facing away from the front loader attachment body. In this case it is e.g. possible that the supporting body comprises a vertical portion which has a vertical orientation in the assembled state and comprises a cross section which does not change significantly or has a cross sectional area which increases in upward direction and which carries the front loader attachment body in the end region. In this case, the supporting body also comprises a horizontal portion providing the frame element attachment portion. In the assembled state of the working vehicle attachment tower this horizontal portion has an orientation approximately in horizontal direction and/or parallel to the longitudinal carrier, the chassis or the drive train of the working vehicle. It is possible that this horizontal portion forms an L-shape together with the vertical portion so that this horizontal portion extends from the vertical portion only towards the front or the rear at the working vehicle. However, it is also possible that the horizontal portion forms an inverted T together with the vertical portion so that at the working vehicle the horizontal portion extends both towards the front and towards the rear. The frame element attachment portion formed by the horizontal portion serves for attaching a frame element when the working vehicle attachment device has a design with two components. Here, the frame element can e.g. be screwed or welded to the frame element attachment portion. It is possible that additionally also a positive form lock is provided (e.g. by means of a connecting cone). The frame element is then attached to the longitudinal carrier, the chassis or the drive train of the working vehicle.

There are a lot of options for the geometry of the frame element attachment portion. Preferably, the frame element attachment portion comprises a larger extension towards the frame or drive train of the working vehicle than a sub-portion of the supporting body (in particular than the vertical portion) arranged adjacent and there above.

In order to mention only one example which is not intended to limit the invention the frame element attachment portion might be embodied as a rectangle having a horizontal orientation. Here, the shape of the edges of the frame element attachment portion might also differ arbitrarily from the rectangular design. For one proposal the frame element attachment portion comprises a convex shaped, concave shaped, curved or meandering edge. This design of the edge is in particular advantageous if the frame element attachment portion on the one hand and the frame element on the other hand are connected by a welding along the edge because the non-straight design of the edge leads to an increase of the lengths of the weld seam.

For one embodiment in particular the frame element attachment portion and (if applicable) the non-straight edge are directly generated by the massive forming process.

Generally, the supporting body might have any cross section and might e.g. have a plate-shaped design. For one proposal the supporting body comprises at least one stiffening rip which might also be generated in the massive forming process. Here, in the state assembled to the working vehicle the stiffening rib extends with its longitudinal extension in the height direction of the supporting body and exclusively or mainly in the region of the vertical portion. The height of the stiffening rib might have an orientation in lateral direction. By the use of the stiffening rib it is possible to increase the moment of inertia of the supporting body which improves the bias of the supporting body with a bending moment and/or with a torsional moment. It is also possible that two (or more) stiffening ribs of this type are provided which might extend parallel or V-shaped in longitudinal direction of the vertical portion. Preferably, at least one stiffening rib is arranged at the lateral outer side when the working vehicle attachment tower has been assembled to the working vehicle. However, it is also possible that at least one stiffening rib is arranged on each of the two lateral outer sides.

Here, two stiffening ribs might also be arranged with in offset to each other in horizontal direction (in particular in the direction of the vehicle longitudinal axis). In this case the stiffening ribs are in particular arranged offset from the so called neutral fiber for the bending of the supporting body.

The stiffening ribs might have any cross section. It is proposed that the stiffening rib comprises a rounded cross section. The rounding might be arranged in the transitional region to the plate-shaped base body of the supporting body or in the region of an outer front face of the stiffening rib. The rounding of the cross section of the stiffening rib leads to advantages for the massive forming process because the rounding eases or improves the floating of the material. It is also possible that the rounding of the stiffening rib eases any painting or varnishing of the working vehicle attachment tower because the paint or varnish can be applied in a better way onto the rounded cross section than into angled grooves or fillets of the cross section.

The separate manufacturing of the supporting body and of the front loader attachment body allows e.g. a choice of the used materials and of the used manufacturing processes and/or of the process parameters in a way such that the hardness and/or strength of the front loader attachment body is higher than the hardness and/or strength of the supporting body. In this way it is e.g. possible that a more expensive material and/or a more complex manufacturing process can be used for the front loader attachment body having a comparatively small volume for the provision of the required increased hardness and/or strengths of the front loader attachment body than for the supporting body which might have a reduced hardness and/or strength. In this way it is possible to reduce the manufacturing effort and/or the cost. In this case the choice of the hardness and/or strength of the front loader attachment body can selectively be adapted to the interaction with the front loader.

Another simplification of the manufacturing process can be achieved by equipping the supporting body with a positioning aid. The positioning aid serves for defining a relative position and/or orientation of the supporting body relative to the front loader attachment body and/or of the supporting body relative to the frame element attachment portion or the frame element. If it is e.g. intended to provide a welding, by use of the positioning aid it is possible to induce the predetermined relative position and/or orientation prior to the welding process wherein the positioning aid might also serve for maintaining the intended relative position and/or orientation during the welding process. Also when providing a connection by means of screwing (e.g. by screwing a frame element attachment portion to a frame element) by means of the positioning aid it is possible to define the relative position and/or orientation between the frame element attachment portion and the frame element. Here, it is possible that a positioning aid of the supporting body cooperates with a counter element of the front loader attachment body, of the frame element attachment portion or of the frame element by providing a kind of stop or abutment between the positioning aid and the counter element. A stop or abutment of this type might only define a position or orientation in one direction or in a plurality of directions. It is also possible that a plurality of positioning aids of these type cooperate for defining the relative position and/or orientation.

In order to mention only some examples which are not intended to limit the invention the extension of the supporting body in longitudinal direction of the working vehicle from the end region of the vertical portion of the supporting body adjoining the frame element attachment portion to the corresponding extension in the end region to which the frame element attachment portion is welded might increase by at least 10%, at least 20%, at least 30%, at least 40% or least 50% or at least 60%.

It is e.g. also possible that the extension of the frame element attachment portion in the direction of the longitudinal axis of the working vehicle is by 20% to 100% larger (in particular 30% to 80% larger) than the extension of the adjacent vertical portion of the supporting body.

It is also possible that other elements are welded to or screwed to the supporting body. It is e.g. possible that a holding element for a component is welded to the supporting body. The component held by the holding element might e.g. be a hydraulic unit, a hydraulic coupling unit and the like. In this case the holding element might e.g. be welded to the upper end region of the vertical portion of the supporting body adjacent to the front loader attachment body.

For the manufacturing of the supporting body by use of a massive forming process any blank can be used. Preferably, the blank is a rod-shaped blank or an extruded profile cut to length or a cuboidal blank or a cast blank.

For one embodiment the supporting body comprises at least one crank or offset which is preferably also manufactured during the massive forming process. The supporting body might e.g. comprise two vertical end regions which have an orientation parallel to each other and which each have a transition to a connecting portion by a crank, the connecting portion serving for providing a lateral offset of the two end regions depended on the inclination and length of the connecting portion. This can in particular be advantageous if the location where the working vehicle attachment tower is attached to the working vehicle has a lateral offset relative to the location where the front loader is attached to the working vehicle attachment tower. This lateral offset can be bridged by the connecting portion.

It is generally possible that the working vehicle attachment tower is used in the state at the end of the massive forming process without additional material processing processes (however, in some cases with an additional painting or varnishing). Preferably, there is a deburring process applied to the supporting body. Here, it is e.g. possible that the deburring of the supporting body is provided already by the massive forming process by using a tool in the massive forming process which already comprises a deburring blade by which the deburring is provided.

The invention also proposes a working vehicle attachment device which comprises a working vehicle attachment tower as explained before and a frame element. The frame element then serves for mounting the working vehicle attachment device to the working vehicle (in particular in the region of a longitudinal carrier, in the region of the drive train or in the region of the chassis). By the choice of the geometry of the frame element an adaption to the connection points at the working vehicle can be provided. It is also possible that by the frame element used together with the working vehicle attachment tower an adaption of the working vehicle attachment device to different types of working vehicles and assembly conditions of the working vehicles can be provided.

It is possible that the frame element in an integral component of the supporting body. Here, the frame element is preferably also manufacturing by use of a massive forming process.

However, it is also possible that the frame element is manufactured separately from the supporting body and the frame element is screwed and/or welded and/or riveted and/or connected by means of a positive form lock and/or adhered to the supporting body (preferably to the frame element attachment portion of the supporting body). Here, it is possible that also a holding element or any other attachment component is attached by means of welding, screwing, riveting, a positive form lock or adhering where for the connection of the aforementioned constructional elements the same or different attachment processes can be used. Additional to a screwing or welding also a positive form lock can be generated which might on the one hand serve for defining the relative position and/or orientation between the frame element and the supporting body and which might on the other hand serve for an additional connection and transfer of forces. For one option a positive form lock of this type it is e.g. possible that a cone-shaped coupling body is used as e.g. being known from the publication FR 2 972 203 A1.

The invention also proposes a set which contains a plurality of working vehicle attachment towers as explained before. In the set the working vehicle attachment towers comprise identical supporting bodies. The plurality of supporting bodies can then be manufactured in one and the same massive forming process and the plurality of supporting bodies can then be non-variable parts for the different working vehicle attachment towers of the set. For this design the working vehicle attachment towers of the set comprise different front loader attachment bodies. The working vehicle attachment towers are then designated for working vehicles of different types.

If e.g. working vehicles of different types comprise different attachment points for the frame element (e.g. with different distances or different relative positons) the working vehicle attachment devices might comprise frame elements having a specific design for the different types so that by use of identical supporting bodies and the use of different frame elements an adaption to the different types of working vehicles is possible. Alternatively or cumulatively it is possible that when using the same supporting bodies in the set different specific front loader attachment bodies can be used for providing a connection of the working vehicle attachment towers to different front loaders with different accommodations or mounting dimensions.

Advantageous developments of the invention result from the claims, the description and the drawings.

The advantages of features and of combinations of a plurality of features mentioned at the beginning of the description only serve as examples and may be used alternatively or cumulatively without the necessity of embodiments according to the invention having to obtain these advantages.

The following applies with respect to the disclosure—not the scope of protection—of the original application: Further features may be taken from the drawings, in particular from the illustrated designs and the dimensions of a plurality of components with respect to one another as well as from their relative arrangement and their operative connection. The combination of features of different embodiments of the invention or of features of different claims independent of the chosen references of the claims is also possible, and it is motivated herewith. This also relates to features which are illustrated in separate drawings, or which are mentioned when describing them. These features may also be combined with features of different claims. Furthermore, it is possible that further embodiments of the invention do not have the features mentioned in the claims which, however, does not apply to the independent claims.

The number of the features mentioned in the claims and in the description is to be understood to cover this exact number and a greater number than the mentioned number without having to explicitly use the adverb “at least”. For example, if an element is mentioned, this is to be understood such that there is exactly one element or there are two elements or more elements. Additional features may be added to these features, or these features may be the only features of the respective product.

The reference signs contained in the claims are not limiting the extent of the matter protected by the claims. Their sole function is to make the claims easier to understand.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 shows a lateral view of a working vehicle attachment device comprising a working vehicle attachment tower and a frame element.

FIG. 2 shows a view of the working vehicle attachment device of FIG. 1 with a viewing direction inclined from above.

FIG. 3 shows the working vehicle attachment device of FIGS. 1 and 2 in a top view.

FIG. 4 shows a subsection of the working vehicle attachment tower of FIGS. 1 to 3 at the mounting portion between a front loader attachment body and an upper end of the supporting body.

FIGS. 5 and 6 show alternatives for the design of the weld seams and the adjoining surfaces in the attachment portion between the supporting body and the front loader attachment body.

### DETAILED DESCRIPTION

In the present application (when not explicitly described in a different way) descriptions for the orientations as “in longitudinal direction”, “in transverse direction”, “in lateral direction”, “vertical” and the like refer to the orientations of the working vehicle to which the inventive working vehicle attachment device is attached. This descriptions also cover orientation which differ by ±10°, ±20° or ±30° from the exact aforementioned orientations.

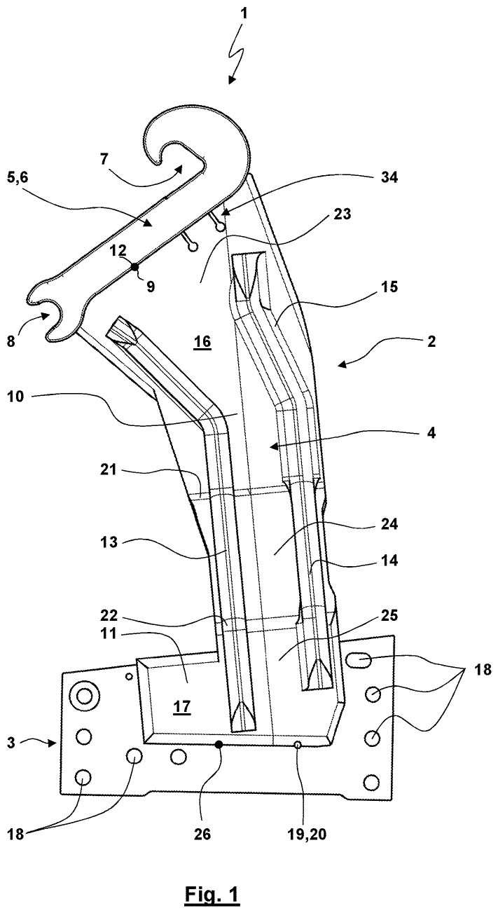

FIG. 1 shows a working vehicle attachment device 1. The working vehicle attachment device 1 comprises a working vehicle attachment tower 2 and a frame element 3. The working vehicle attachment tower 2 again comprises a supporting body 4 and front loader attachment body 5 which are welded to each other.

In FIG. 1 the front loader attachment body 5 is shown in an embodiment which is colloquially denoted as bone 6. The front loader attachment body 5 comprises two accommodations 7, 8 wherein a corresponding accommodation body of the front loader can be arranged and can preferably be locked so that a rigid fixation of an end region of the front loader on the front loader attachment body 5 is provided.

On the lower side the front loader attachment body 5 comprises a front face 9. The front face 9 comprises a centered flat subportion and curve-shaped end portions. The front loader attachment body 5 is in particular manufactured by a massive forming process or forging.

The supporting body 4 comprises a vertical portion 10 and a horizontal portion 11. For the embodiment shown here the vertical portion 10 and the horizontal portion 11 in the side view form a (mirrored) L. Here, the horizontal portion 11 might extends towards the front or towards the back. However, it is also possible that the horizontal portion 11 extends on both sides of the vertical portion 10 so that the supporting body has the shape of an inverted T.

In the region of the vertical portion 10 the extension of the vertical portion 10 in the direction of the longitudinal axis of the working vehicle changes wherein this extension continuously increases from the horizontal portion 11 towards the front loader attachment body 5. This change of the extension considers the mechanical bias of the supporting body 4 due to the forces applied by the front loader on the same.

In the upper end region the vertical portion 10 comprises a front face 12 where the front face 9 contacts the supporting body 4. Here, the contour of the front face 12 in the side view corresponds to the contour of the front face 9.

In the region of the vertical portion 10 stiffening ribs 13, 14 extend in vertical direction. The stiffening ribs 13, 14 also continue in the horizontal portion 11 as shown. In the lower subsection of the vertical portion 10 the stiffening ribs 13, 14 have an orientation approximately parallel to each other whereas in the upper subsection of the vertical portion 10 the stiffening ribs 13, 14 diverge V-shaped in upper direction. Here, the stiffening ribs 13, 14 preferably follow the course of the associated front and rear edges of the vertical portion 10. The stiffening ribs 13, 14 here comprise the same or changing cross sectional geometries. Preferably, the stiffening ribs 13, 14 transit via roundings 15 to a base body 16 of the supporting body 4.

The supporting body 4 manufactured by use of a massive forming process. Here, it is possible that the front face 12 is already manufactured in the massive forming process without any post-processing of the front face 12 being required. Also the stiffening ribs 13, 14 and/or the horizontal portion 11 are manufactured in the massive forming process preferably from a blank without an additional post-processing being required.

The horizontal portion 11 of the supporting body 4 forms a frame element attachment portion 17. The frame element 3 is fixed to the frame element attachment portion 17 which might be provided by providing a welding along the edge of the frame element mounting portion 17 or might be provided by screwing, in this case (differing from the shown embodiment) corresponding bores being provided in the frame element attachment portion 17 and the frame element 3.

As can be seen in FIG. 1 the frame element 3 comprises a plurality of mounting bores 18. By means of the mounting bores 18 it is possible to fix the frame element 3 on the working vehicle.

It is optionally possible that the supporting body 4 comprises a positioning aid 19 on the frame element attachment portion 17. The positioning aid 19 interacts with a counter element 20 of the frame element 3. For the shown embodiment the positioning aid 19 is a semi-cylindrical recess wherein the counter element 20 embodied as a cylindrical pin can be accommodated. Prior to the attachment of the supporting body 4 at the frame element 3 it is possible to define the relative positon and/or orientation of the supporting body 4 relative to the frame element 3 by means of the interaction between the positioning aid 19 and the counter element 20. It is possible that a plurality of positioning aids 19 can be provided on to supporting body 4. In this case, different positioning aids 19 can be used for connecting the supporting body 4 to different frame elements 3. Alternatively or cumulatively it is possible that frame elements 3 having different geometries for the connection with working vehicles of different type comprise a counter element 20 at a suitable location which then each interact with the same positioning aid 19 of the supporting element 4 for then specially defining the relative position and/or orientation of the respective frame element 3 relative to the supporting body 4. For the shown embodiment the interaction between the positioning aid 19 and the counter element 20 still allows a remaining degree of freedom between the supporting body 4 and the frame element 3 prior to the connection of the same. It will be understood that also other positioning aid 19 and counter elements 20 might be provided for further defining the relative position and/or orientation.

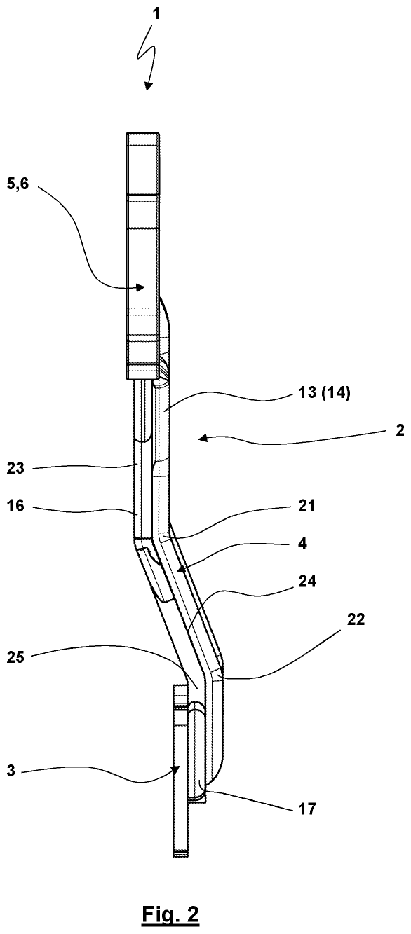

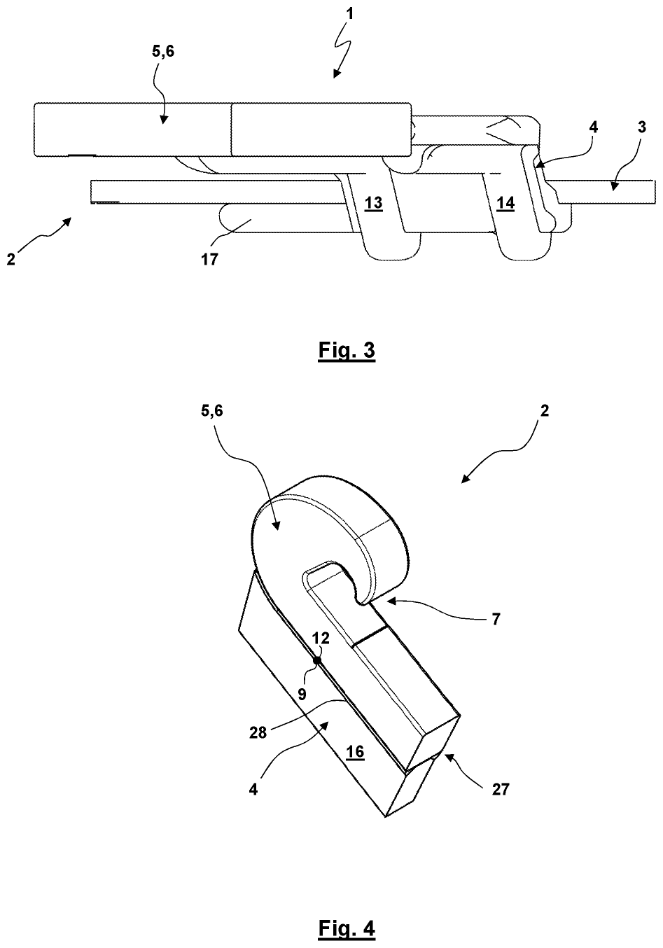

FIGS. 2 and 3 show that the vertical portion 10 of the supporting body 4 is cranked or has an offset in lateral direction with cranks or offsets 21, 22. The cranks or offsets 21, 23 might have any curved shape or also offsets. An upper end region 23 of the supporting body 4 transits via the crank or offset 21 to a connecting portion 24 which again transits via the crank 4 or offset 22 to a lower end region 25 which preferably has an orientation parallel to the end region 23. It is possible to provide a lateral offset of the end regions 23, 25 by the cranks or offsets 21, 22 and the connecting portion 24. In this way a lateral offset of the front loader attachment 5 relative to the frame element attachment portion 17 and so relative to the frame element 3 and the working vehicle can be provided.

If the frame element attachment portion 17 is welded to the frame element 3, differing from FIG. 1 an edge 26 of the frame element attachment portion 17 might not have a straight design but might have any curved shape in order to increase the length of the weld seam.

FIG. 4 shows the working vehicle attachment device of FIGS. 1 to 3 in a subsection at an attachment portion 27.

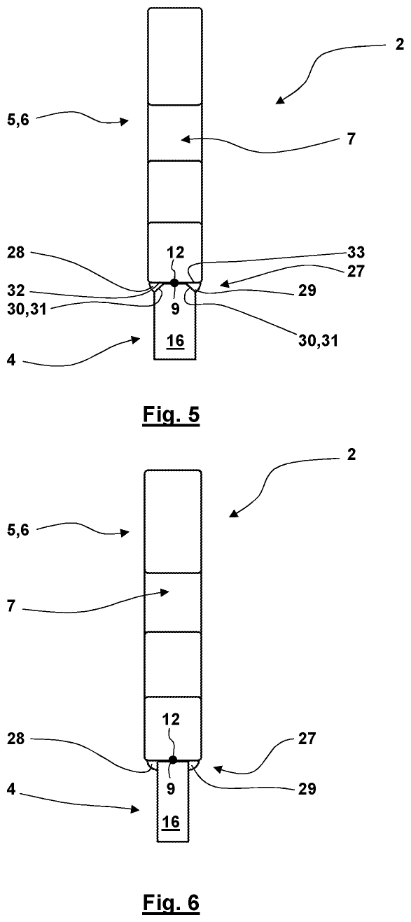

In the plan view of the attachment portion 27 of FIG. 5 it can be seen that in the attachment portion 27 the front loader attachment body 5 has a larger lateral extension than the supporting body 4. Here, the lateral extension of the supporting body 4 in the attachment portion 27 might correspond to the wall thickness of the base body 16 of the supporting body 4. For nevertheless allowing that weld seams 28, 29 having a large cross section (in some cases also with a plurality of weld seams arranged one above the other) can be used, in the transitional region to the front face 12 the supporting body 4 comprises a chamfered edge 30 on both sides or a portion 31 of reduced thickness. Accordingly, on both sides of the separating gap between the front faces 9, 12 or of the contact area between these (e.g. V-shaped) recesses 23, 33 are formed between the supporting body 4 and the front loader attachment body. The weld seams 28, 29 can then be arranged in this recesses 32, 33. The weld seams 28, 29 laterally protrude from the upper end region of the supporting body 4 without protruding laterally beyond the front loader attachment body 5.

FIG. 6 shows an embodiment wherein no chamfered edge 30 or no portion 31 is required because the difference of the lateral extension of the supporting body 4 and the lateral extension of the front loader attachment body 5 in the region of the front faces 9, 12 is so large that a weld seam 28, 29 having a sufficient cross section can be applied in the region of the resulting step without any protrusion of the weld seam 28, 29 laterally beyond the front loader attachment body 5.

It is possible that at least one stiffening rib 13, 14 is arranged only on one side of the supporting 4. However, it is also possible that on both sides of the supporting body 4 at least one stiffening 13, 14 is arranged.

For fixing the frame element attachment portion 17 to the frame element 3 and/or for fixing the frame element 3 to the working vehicle also cone-shaped connecting and/or centering bodies known from the prior art can be used.

Preferably, the weld seams 28, 29 comprise two, three, four, five or more weld seam layers.

FIG. 1 shows the further optional feature that the supporting body 4 might comprise a holding element 34 for the fixing of another component on the supporting body. Here, the holding element 34 can be manufactured by the massive forming process for manufacturing the supporting body 4. However, it is also possible that a holding element 34 of this type is subsequently welded to the supporting body 4.

It is possible that components of the working vehicle attachment device 1 which have to be connected to each other do not only (as for the shown embodiment) contact each other and are not only fixed to each other by means of weld seams or screwings but that there is an additional shaping of the contact and connection points in a way such that at least parts of the forces are transmitted by a positive form lock of the contact surfaces.

The frame element 3 is preferably embodied as a metal sheet component which can also be shaped by a metal sheet deformation process. It is also possible that the frame element 3 is manufactured as a welded constructional group. It is possible that the metal sheet which forms the frame element 3 or metal sheets which then form the frame element 3 being a welded constructional group are cut in a plasma cutting process.

It is possible that the frame element 3 also comprises jog notches or recess areas.

It is furthermore possible that the supporting body 4, the working vehicle attachment device 1 and the working vehicle attachment towers 2 and/or the frame elements 3 have the same or different designs on different sides of the working vehicle.

Many variations and modifications may be made to the preferred embodiments of the invention without departing substantially from the spirit and principles of the invention. All such modifications and variations are intended to be included herein within the scope of the present invention, as defined by the following claims.

I claim:

1. A working vehicle attachment tower comprising a front loader mounting body and a supporting body,
a) the front loader mounting body and the supporting body being manufactured as separate parts,
b) the front loader mounting body and the supporting body being welded to each other by at least one weld seam and
c) the supporting body being manufactured by use of a massive forming process in which a three-dimensional blank is deformed three-dimensionally.

2. The working vehicle attachment tower of claim 1, wherein in a region of the weld seam by which the front loader mounting body is welded to the supporting body the supporting body comprises a chamfered edge or a portion having a reduced thickness, the weld seam being arranged in a region of the chamfered edge or the portion having a reduced thickness.

3. The working vehicle attachment tower of claim 1, wherein
a) the supporting body comprising a first front face being shaped in the massive forming process with or without a subsequent post processing,
b) the front loader mounting body comprising a second front face and
c) the front loader mounting body and the supporting body being welded to each other by a weld seam connecting the first front face and the second front face, the weld seam being welded to the first front face being a massive forming front face which has been shaped in the massive forming process with or without a subsequent post processing.

4. The working vehicle attachment tower of claim 2, wherein
a) the supporting body comprising a first front face being shaped in the massive forming process with or without a subsequent post processing,
b) the front loader mounting body comprising a second front face and
c) the front loader mounting body and the supporting body being welded to each other by a weld seam connecting the first front face and the second front face, the weld seam being welded to the first front face being a massive forming front face which has been shaped in the massive forming process with or without a subsequent post processing.

5. The working vehicle attachment tower of claim 1, wherein that also the front loader mounting body is manufactured by a massive forming process or a forging process.

6. The working vehicle attachment tower of claim 3, wherein the first front face and the second front face are manufactured in the massive forming process with a tolerance of ±1 mm.

7. The working vehicle attachment tower of claim 4, wherein the first front face and the second front face are manufactured in the massive forming process with a tolerance of ±1 mm.

8. The working vehicle attachment tower of claim 1, wherein in an end region facing away from the front loader mounting body the supporting body comprises a frame element mounting portion.

9. The working vehicle attachment tower of claim 8, wherein the frame element mounting portion comprises a larger extension in longitudinal direction of a working vehicle than an adjacent sub-portion of the supporting body.

10. The working vehicle attachment tower of claim 8, wherein the frame element mounting portion comprises one of a convex shaped edge, a concave shaped edge, a curved edge or a meandering edge.

11. The working vehicle attachment tower of claim 1, wherein the supporting body comprises at least one stiffening rib.

12. The working vehicle attachment tower of claim 8, wherein the supporting body comprises at least one stiffening rib.

13. The working vehicle attachment tower of claim 12, wherein at least one stiffening rib extends from the frame element mounting portion towards the front loader mounting body.

14. The working vehicle attachment tower of claim 11, wherein two stiffening ribs are arranged with an offset relative to each other in horizontal direction.

15. The working vehicle attachment tower of claim 11, wherein at least one stiffening rib comprises a rounded cross section.

16. The working vehicle attachment tower of claim 1, wherein due to
a) a chosen material and/or
b) a used manufacturing process and/or process parameters used during a manufacturing process
a hardness and/or strength of the front loader mounting body is higher than a hardness and/or strength of the supporting body.

17. The working vehicle attachment tower of claim 1, wherein the supporting body comprises a positioning aid for defining a relative position of
a) the supporting body relative to the front loader mounting body and/or
b) the supporting body relative to a frame element.

18. The working vehicle attachment tower of claim 1, wherein a holding element for a component is welded to the supporting body.

19. The working vehicle attachment tower of claim 1, wherein the supporting body is manufactured by use of a massive forming process from one of a rod-shaped blank, an extruded profile cut to length, a cuboidal blank and a cast blank.

20. The working vehicle attachment tower of claim 1, wherein the supporting body comprises at least one crank or offset.

21. The working vehicle attachment tower of claim 1, wherein the supporting body is not embodied as a cast component.

22. A working vehicle attachment device comprising
a) a working vehicle attachment tower comprising a front loader mounting body and a supporting body,
aa) the front loader mounting body and the supporting body being manufactured as separate parts,
ab) the front loader mounting body and the supporting body being welded to each other and
ac) the supporting body being manufactured by use of a massive forming process and
b) a frame element.

23. The working vehicle attachment device of claim 22, wherein the frame element is manufactured together with the supporting body.

24. The working vehicle attachment device of claim 22, wherein the frame element is manufactured separately from the supporting body and the frame element is
a) screwed and/or
b) welded and/or
c) riveted and/or
d) connected by means of a positive form lock and/or
e) adhered
to the supporting body.

25. Set of a plurality of working vehicle attachment towers, the working vehicle attachment towers of the set each comprising a front loader mounting body and a supporting body, the front loader mounting body and the supporting body being manufactured as separate parts, the front loader mounting body and the supporting body being welded to each other and the supporting body being manufactured by use of a massive forming process, wherein
a) the working vehicle attachment towers of the set comprise identical supporting bodies and
b) the working vehicle attachment towers of the set comprise different front loader mounting bodies, the different front loader mounting bodies differing in that they have a specific design such that the different front loader mounting bodies are designated for working vehicles or front loaders of different types.

26. A method for manufacturing a working vehicle attachment tower, the method comprising
a) forming a supporting body by a massive forming process in which a three-dimensional blank is deformed three-dimensionally;
b) providing a front loader mounting body manufactured separately from the supporting body; and
c) welding the front loader mounting body to the supporting body.

27. The method of claim 26, wherein the supporting body comprises a first front face shaped in the massive forming process, wherein the front loader mounting body comprising a second front face and wherein the step of welding the front loader mounting body to the supporting body comprises welding the first front face to the second front face by a weld seam.
